(19) United States
(12) Patent Application Publication
(10) Pub. No.: US 2010/0259667 A1
(43) Pub. Date: Oct. 14, 2010

(54) CAMERA MODULE FOR TAKING WIDE ANGLE IMAGES AND PORTABLE ELECTRONIC DEVICE HAVING SAME

(75) Inventors: Kun-I YUAN, Tu-Cheng (TW); Ho-Chiang LIU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/648,018

(22) Filed: Dec. 28, 2009

(30) Foreign Application Priority Data
Apr. 8, 2009 (CN) 200910301403.9

(51) Int. Cl. H04N 5/225

(52) U.S. Cl. 348/335; 348/E05.024

(57) ABSTRACT

An exemplary camera module for mounting to a base and capturing an image of a top surface of the base is provided. The camera module includes a reflective mirror having a curved reflective surface, a lens, and an image sensor in optical alignment with the lens. The curved reflective surface is configured for reflecting light from the top surface of the base to the lens.

### BACKGROUND

1. Technical Field

The present disclosure relates to optical imaging, and particularly to a camera module for taking wide angle images and a portable electronic device having the camera module.

2. Description of Related Art

With the development of the optical imaging technology, camera modules are widely used in a variety of portable electronic devices, such as mobile phones, and personal digital assistants (PDAs).

However, view angle of a typical camera module is generally not large enough (e.g., 60° to 65°. Therefore, such portable electronic devices are not suitable for taking wide angle images.

Therefore, a new camera module is desired to overcome the above-mentioned problems.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic, cross-sectional view of a camera module and an object to be photographed by the camera module according to a first embodiment.

FIG. 2 is a schematic, cross-sectional view of a camera module and an object to be photographed by the camera module according to a second embodiment.

### DETAILED DESCRIPTION

Embodiments will now be described in detail below with reference to the drawings.

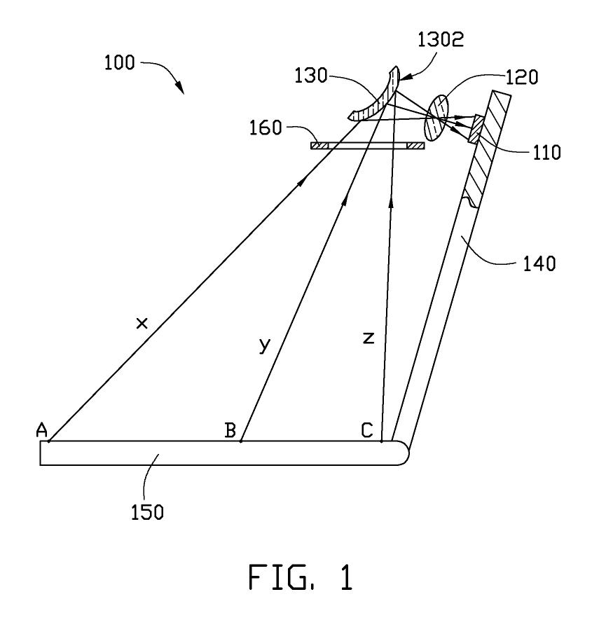

Referring to FIG. 1, a camera module 100 according to a first embodiment is shown. The camera module 100 includes a diaphragm 160, a reflective mirror 130, a lens 120, and an image sensor 110.

The camera module 100 is used in a portable electronic device, such as a touch panel. In the present embodiment, the portable electronic device (not labeled) includes a base 150 and a supporting arm 140 pivotedly coupled to the base 150. The base 150 can include a touch panel (not shown). The image sensor 110 is fixedly mounted on the supporting arm 140. The camera module 100 is for capturing an image of a top surface of the base 150.

The diaphragm 160 is configured for adjusting an amount of light incident into the camera module 100.

The reflective mirror 130 includes a curved reflective surface 1302. The curved reflective surface 1302 can be a spherical surface or an aspherical surface. The curved surface 1302 is configured for reflecting light from the top surface of the base 150 towards the lens 120, thereby enlarging a view angle of the camera module 100. In the present embodiment, the curved reflective surface 1302 is a convex surface. An absolute value of the focal length of the camera module 100 is less than half of an absolute value of the curvature of the curved reflective surface 1302.

The lens 120 is for forming an image associated with the top surface of the base 150 on the image sensor 110. The geometric center B of the top surface of the base 150, the geometric center of the lens 120 and the geometric center of the image associated with the top surface of the base 150 are non-collinear. The geometric center B of the top surface of the base 150, the geometric center of the curved reflective surface 1302 and the geometric center of the image are non-collinear. The reflective mirror 130 and the lens 120 can be received in a barrel (not shown).

The image sensor 110 is fixedly mounted on a printed circuit board (not shown) inside a camera (not shown). The image sensor 110 is in optical alignment with the lens 110.

In operation, three points A, B, and C emits light rays x, y, and z towards the camera module 100 respectively. The light rays x, y and z are reflected by the reflective mirror 130 to the lens 120. Then the lens 120 forms the image associated with the top surface of the base 150 on the image sensor 110.

Because the curved reflective surface 1302 can reflect light within a large view angle, the camera module 100 with the curved reflective surface 1302 has a large view angle.

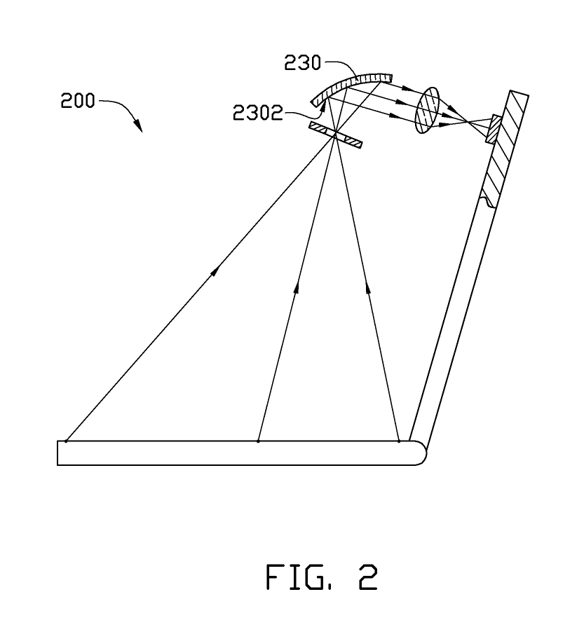

Referring to FIG. 2, a camera module 200 according to a second embodiment is shown. The camera module 200 is similar to the camera module 100 of FIG. 1, except that the camera module 200 includes a reflective mirror 230 having a concave reflective surface 2302.

While certain embodiments have been described and exemplified above, various other embodiments from the foregoing disclosure will be apparent to those skilled in the art. The present invention is not limited to the particular embodiments described and exemplified but is capable of considerable variation and modification without departure from the scope and spirit of the appended claims.

What is claimed is:

1. A camera module for mounting to a base and capturing an image of a top surface of the base, the camera module comprising:
a reflective mirror having a curved reflective surface;
a lens, the curved reflective surface being configured for reflecting light from the top surface of the base to the lens; and
an image sensor in optical alignment with the lens.

2. The camera module of claim 1, wherein the curved reflective surface is a spherical surface.

3. The camera module of claim 1, wherein the curved reflective surface is a convex surface.

4. The camera module of claim 1, wherein the curved reflective surface is a concave surface.

5. The camera module of claim 1, wherein an absolute value of a focal length of the camera module is less than half of an absolute value of the curvature of the curved reflective surface.

6. A portable electronic device comprising:
a base;
a camera module mounting to the base and configured for capturing an image of a top surface of the base, the camera module comprising:
a reflective mirror having a curved reflective surface;
a lens, the curved reflective surface being configured for reflecting light from the top surface of the base to the lens; and
an image sensor, the lens being configured for forming an image associated with the top surface of the base on the image sensor,
wherein a geometric center of the top surface of the base, a geometric center of the lens and a geometric center of the image associated with the top surface of the base are non-collinear.

7. The portable electronic device of claim 6, wherein the curved reflective surface is a spherical surface.

8. The portable electronic device of claim 6, wherein the curved reflective surface is a convex surface.

9. The portable electronic device of claim 6, wherein the curved reflective surface is a concave surface.

10. The portable electronic device of claim 6, wherein an absolute value of a focal length of the camera module is less than half of an absolute value of the curvature of the curved reflective surface.

11. The portable electronic device of claim 6, wherein the geometric center of the top surface of the base, a geometric center of the curved reflective surface and the geometric center of the image are non-collinear.

12. The portable electronic device of claim 6, further comprising a supporting arm pivotedly coupled to the base, wherein the camera is fixedly mounted on the supporting arm.

13. A camera module for mounting to a base and capturing an image of a top surface of the base, the camera module comprising:
a reflective mirror having a curved reflective surface;
a lens, the curved reflective surface being configured for reflecting light from the top surface of the base to the lens; and
an image sensor in optical alignment with the lens, wherein an absolute value of a focal length of the camera module is less than half of an absolute value of the curvature of the curved reflective surface.

14. The camera module of claim 13, wherein the curved reflective surface is a spherical surface.

15. The camera module of claim 13, wherein the curved reflective surface is a convex surface.

16. The camera module of claim 13, wherein the curved reflective surface is a concave surface.
